(19) United States
(12) Patent Application Publication
(10) Pub. No.: US 2014/0288676 A1
(43) Pub. Date: Sep. 25, 2014

(54) Computer, phone, and mobile communication, and production, of touch

(71) Applicant: Sivatharan Natkunanathan, Irvine, CA (US)

(72) Inventor: Sivatharan Natkunanathan, Irvine, CA (US)

(21) Appl. No.: 13/815,939

(22) Filed: Mar. 18, 2013

(51) Int. Cl. G05B 15/02

(52) U.S. Cl. CPC G05B 15/02
USPC 700/83

(57) ABSTRACT

A system or process for performance of touch comprising heat and/or motion, by means of, a standalone or network computer, or a phone, and/or a “touch-device” named or classified a “TOUCHDEV”, or “MOBILE TOUCHDEV”, is the subject of this invention. Touch information in a machine-device or touch-device, comprising an operating system, program, application, service, or platform, is communicated with means comprising of a connection to a touch-device with means comprising of a device driver, for performance of touch. The performance of touch by means of a machine-device and/or a touch-device, comprises, a user, client, user-client, host, machine-device, or touch-device, processing, storing, communication, and/or production, of touch, by means comprising of a network.

A related invention is a mobile personal touch-device, named or classified a “MOBILE TOUCHDEV”, comprising user-controls for PERFORMANCE of touch comprising heat and/or motion. The said device is user or client controlled for operation of said device. The said MOBILE TOUCHDEV is a consumer product.

### BACKGROUND OF THE INVENTION

The idea for this invention was materialized during the days of communicating by means of, a network computer with means of e-mail, and internet phone; and a conventional, and mobile phone. A user, client, or user-client, communicates by means of a network computer comprising of the internet, elements comprising: text, hyperlink, or static image with means of a web page; text, hyperlink, or document attachment with means of an e-mail program, application, service, or platform; text with means of a text chat program, application, service, or platform; and voice or audio with means of an internet phone program, application, service, or platform. Similarly, a user, client, or user-client, communicates by means of a phone, elements of voice or audio. The said electronic means present limited elements in communication, as compared to elements naturally communicated during real-life events.

The quality of communication by means of a computer or phone is far removed from real-life events, as compared to, receiving hugs from father or mother, providing hugs, or holding kids, while on travel, shoulder massaging after a sporting event, holding hands of a loved one, or the like. The solution therefore, comprises enhancements in systems, and processes, for communicating elements that stimulate the human physiological senses during a real-life event. However, even when communication by means of a computer or phone is cumbersome in performance of elements perceived during real-life events, the communication system or process of this invention, presents elements in communication for the perception, comprising of real-life events, with means of the physiological senses of a user, client, or user-client.

This invention presents the communication, and production, of “touch”, for the perception of touch by a user, client, or user-client, with means for performing of touch comprising electronic means. The word “touch” as defined herein, comprises, a production, output, contact, or a combination, comprising pressure, rub, impact, pain, or a variation or combination thereof, to a surface comprising a body surface contacting said touch-device. The element of touch, when communicated by means of a computer or phone, means with standalone or network communication, presents the additional element of touch in said communication.

The system or process for performance of touch, by the said means, is referred to herein as “TOUCHCOM”, which is new, or an enhancement, in communication and/or production of touch. A said TOUCHCOM system or process, enhances, communication of touch to, and/or production of touch in, the quality of real-life events.

The word “machine-device” as defined herein, comprises, a standalone or network computer, or a phone. A said computer comprises a device, apparatus, or machine, with means of, or by means of, an electronic controller and/or a microcontroller for performance of touch. The word “touch-device” as defined herein, comprises, a touch device, a personal touch device, or a variation thereof. The word “production” as defined herein, comprises a production, output, contact, or a combination, comprising for a sensation of touch from, or on, a source of touch or “touch-source”.

The word “perform” or “performance” by means of a machine-device or a touch-device comprises processing, storing, communication, and/or production, of touch by means of, a machine-device, a machine-device with means of a connection to a touch-device, or a touch-device.

The word “PERFORM” or “PERFORMANCE” by means of a machine-device or a touch-device comprises processing, storing, communication, and/or production, of touch by means of, a machine-device with means of a connection to a touch-device, or a touch-device.

A TOUCHCOM system or process comprises of two independent systems or processes, one that comprises performing communication of touch, and the other that comprises PERFORMING production of touch. The said systems or processes, detailed herein individually, and as an interdependent unitary whole, present the fundamentals for performance of touch, by the said means.

A standalone or network computer, or a phone, comprises PERFORMANCE of touch, with means of a connection to a touch-device, apparatus, or machine. The said touch-device, apparatus, or machine, is referred to herein as a device, namely a “TOUCHDEV”. The said TOUCHDEV comprises a permanent, desktop, or stationary touch-device, or a “PM-TOUCHDEV”.

Another related invention presented herein, is a personal touch-device, apparatus, or machine, for performance of touch. The said personal touch-device, apparatus, or machine, is referred to herein as a device, namely, a “MOBILE TOUCHDEV” when mobile, comprising within the definition a non-mobile personal touch-device, namely an “E-TOUCHDEV”. A said touch-device employs a TOUCHCOM system or process for PERFORMANCE of touch. A said MOBILE TOUCHDEV comprises presenting to a user, a mobile touch-device for PERFORMANCE of touch.

A TOUCHDEV, and a MOBILE TOUCHDEV, device, apparatus, or machine, for purposes of simplicity, is referred to as a TOUCHDEV device, and a MOBILE TOUCHDEV device, respectively. The word “touch” as defined earlier, alternatively refers to pressure, rub, impact, pain, or a variation or combination thereof, which is produced, output, contacted, or combined, by means of a touch-device.

1. Introduction

The scope of this invention is performance of touch, by means of, a machine-device comprising (1) a standalone or network computer, or (2) a phone, and/or (3) a touch-device comprising a TOUCHDEV, or (4) a mobile personal touch-device comprising a MOBILE TOUCHDEV.

The system or process for performance of touch, by means of a said machine-device [(1), and (2)] and/or a touch-device [(3), and (4)], is referred to as “TOUCHCOM”. As defined herein, “touch information” comprises any information of touch, utilized for performance thereof, comprising user-controls on a touch-device.

2. Description of Prior Art

Prior art relating to performing communication of touch by means of electronic devices, is minimal or non-existent. Some examples of prior art relating to performing production of touch, are described herein-following.

Prior art relating to performing production of touch, comprises, the making of dolls, mannequins, and hugging bears, with an embodiment, comprising a power source, for production of a sensation of touch. Another prior art, comprises production of touch, when an individual subjects himself to resting on furniture, exercising on a fitness machine, or hugging a stand-up doll. A further prior art, comprises the use of appliances for producing an assortment of touch sensations, as in the case of a massager appliance, comprising a power supply. The most utilized, is production of touch by means of manual application of pressure with means comprising of a soft, spongy, rubbery, or rough, material product.

The fundamental prior art is performing production of touch from a natural source, comprising hugging parents, children, loved ones, or pets, and designed prior art is performing production of touch from a designed, developed, or manufactured source, comprising a doll, massager, or the like.

3. Objectives and Advantages

The objective of this invention is performance of touch, by means of a computer or phone machine-device and/or a touch-device. The said invention presents to a user, client, or user-client, the means necessary for communication of the element of touch, by means of a machine-device and/or a touch-device. The communication of the element of touch by the said means, enhances a communication system or process thereof, for a perception of touch by a user, client, or user-client, comprising of real-life events. It enhances a said system or process, with the additional element of touch, comprising network touch communication.

A further objective of this invention is a TOUCHCOM system or process for PERFORMANCE of touch, by means of a touch-device with means comprising of a connection to a machine-device. A touch-device comprises optional user-controls for manual PERFORMANCE of touch therewith, thereon or therefrom, with or without means of a connection to a machine-device, comprising co-PERFORMANCE. The said TOUCHCOM, presents a robust, flexible, and/or rugged touch-device for PERFORMANCE of a sensation of touch.

The objective of the related invention, namely MOBILE TOUCHDEV, is in presenting to a user, a personal touch-device with means comprising user-controls for PERFORMANCE of touch. A TOUCHCOM system or process is employed, for PERFORMANCE of touch therewith, thereon, or therefrom, comprising during user possession of said touch-device. A MOBILE TOUCHDEV is travel friendly, and PERFORMS touch on a user-control setting or selection thereon. A MOBILE TOUCHDEV comprises an optional feature, for a machine-device PERFORMANCE of touch, with mean of a connection thereto.

A TOUCHCOM system or process, comprises, an operating system, program, application, service, or platform, on a machine-device or touch-device; internal communication within, comprising for performance of touch by means of, a machine-device or touch-device; a machine-device communication to a touch-device; user-controls on a touch-device; and network communication on a machine-device or touch-device; for the performance of touch.

The utility of a TOUCHCOM system or process, comprises, performance of touch form, to, or on, a source of interest to a user, client, or user-client, with means of a machine-device or touch-device. A further utility of TOUCHCOM comprises advertising, marketing, or sale of a product, or products, comprising of a sensation of touch. The performance of network communication of touch information by means of a network machine-device, presents to a user, client, or user-client, a network TOUCHCOM with coverage of use comprising spanning the networked globe.

### SUMMARY OF THE INVENTION

The system or process of this invention, namely TOUCHCOM, comprises performance of touch by means of, a computer or phone machine-device with means comprising of a connection to a touch-device, or a touch-device with means comprising for a connection to a machine-device or touch-device.

The products of this invention comprise hardware, software, and hybrid, TOUCHCOM system or process parts, components, sub-systems, and systems. The said products enable said TOUCHCOM comprising for asynchronous and/or real-time performance of touch, by means of a machine-device and/or a touch-device.

A TOUCHCOM utilizes touch information inputted (“INPUT”) by means of, a user, client, user-client, host, machine-device, or touch-device; an electronic storage device; a touch sensor; receiving comprising accessing from another user, client, user-client, host, machine-device, or touch-device; or any other means; into a user, client, user-client, host, machine-device, or touch-device, for performance of touch. The said performance comprises, processing comprising customization, storing, and/or communicating, of touch information for performance of touch, with means comprising of an operating system, program, application, service, or platform, on a machine-device or touch-device.

An important aspect of this invention is communication of the additional element of touch, by means of a machine-device and/or touch-device, by means comprising of a network. The scope of this invention comprises user, client, user-client, host, machine-device, or touch-device communication, and use or applications of TOUCHCOM for personal, informational, social, and professional purposes.

A further aspect of this invention is in presenting new touch-devices for PERFORMANCE of touch, named or classified, a TOUCHDEV comprising a PM-TOUCHDEV, or a MOBILE TOUCHDEV comprising an E-TOUCHDEV. The said PM-TOUCHDEV, and E-TOUCHDEV, are described and explained herein-later.

A TOUCHDEV PERFORMANCE of touch, comprises, when a machine-device communicates touch information with means of a connection thereto. A said machine-device performs communication of touch information to a TOUCHDEV, for activation, deactivation, or PERFORMANCE of touch. The said TOUCHDEV communication, comprises, an external communication from a machine-device and/or a manual user-control input thereinto, and internal communication therewithin, for PERFORMANCE of touch.

Similarly, a MOBILE TOUCHDEV PERFORMANCE of touch comprises on a user-control setting or selection thereon. The said MOBILE TOUCHDEV communication, comprises, a manual user-control input thereinto and/or an external communication from a machine-device with means of a connection thereto, and internal communication therewithin, for PERFORMANCE of touch.

A TOUCHCOM system or process for PERFORMANCE of touch comprises an optional touch controller, referred to herein as “TOUCHCNTRLR”. The said TOUCHCNTRLR is either external to, or integrated on, a said touch-device. An external TOUCHCNTRLR is a part, component, or subsystem, in the connection between a machine-device and a touch-device. An integrated TOUCHCNTRLR whereas, is a part, component, or subsystem, on a touch-device. The said TOUCHCNTRLR functions as a buffer, or a safety device, subjecting limitations on the PERFORMANCE of touch on said touch-device.

A TOUCHCOM system or process presents the necessary communication element, with means comprising of “touch data communication”, for performance of touch by means of a machine-device and/or touch-device. The said TOUCHCOM thereof, enhances communication of touch information comprising with the said means, comprising the additional element of touch.

Herein-following is a brief summary of the utility, use, and applications, of a TOUCHCOM system or process by means of, a standalone or network computer, a phone, and a MOBILE TOUCHDEV. The utility, use, and applications, described herein are however not a limitation of a TOUCHCOM, nor a touch-device.

(1) Standalone Computer: A standalone computer machine-device, as defined herein, is a computer not connected to a network, comprising of the internet. The said standalone computer employs a TOUCHCOM system or process for performance of touch, with means comprising of a connection to a touch-device. The said TOUCHCOM on a standalone computer machine-device has use, and applications, comprising for personal, informational, social, and professional purposes.

A said use of TOUCHCOM is facilitated by means of an INPUT of touch information into said standalone computer, comprising to a user or client program, application, service, or platform, that processes, stores, and/or communicates, the said touch information for performance of touch.

The personal applications of TOUCHCOM comprise performance of touch for personal purposes, such as a sensation of touch for personal reasons, or family fulfillment. The informational applications of TOUCHCOM comprise performance of touch for informational purposes, such as in advertising or marketing a product comprising of a sensation of touch. The social applications of TOUCHCOM comprise performance of touch for social purposes, such as a memo, greeting, document, or a memorabilia soft copy of an autobiography or interview, with associated touch information comprising for performance. A further social application comprises, a computer game, or “image content” from a party, graduation, wedding, or the like, with associated information on touch comprising for performance. The professional applications of TOUCHCOM, comprise, sampling of a product, or products, comprising of a sensation of touch. A sample may comprise a sensation of touch for testing, or selection, employed in adverting, marketing, or sale, of a product comprising of a sensation of touch. An example comprises sampling a garment, cloth material, suit, or dress, or a brand variety thereof, with a sensation of touch.

The other uses or applications of TOUCHCOM by means of a standalone computer machine-device, comprise PERFORMANCE of touch during use of a program, application, service, or platform. Another use or application comprises PERFORMANCE of touch during performing display comprising of, text, hyperlink, audio, image, or moving picture, by means of a said standalone computer. A further use or application is employing a standalone computer for PERFORMANCE of touch with means of a touch-device.

The said examples explain the utility, use, and applications of TOUCHCOM, overlapping in the purpose of use or application by means of, a standalone computer machine-device with means comprising of a connection to a touch-device, or a touch-device with means comprising for a connection to a said machine-device.

(2) Networked Computer: A network computer machine-device, as defined herein, is a computer connected to a network, comprising of the internet. The said network computer employs a TOUCHCOM system or process, for performance of touch with means comprising of a connection to a touch-device. The said TOUCHCOM on a network computer machine-device has use, and applications, comprising for personal, informational, social, and professional purposes.

The touch information INPUT into, and performance of touch by means of, a network computer machine-device, is similar to that of a standalone computer machine-device, with the contrast being additional TOUCHCOM capabilities on said network computer comprising for processing, storing, and/or communicating, of touch information for performance by means comprising of a network.

The use or applications of TOUCHCOM by means of a network computer machine-device, comprises said use or applications by means of a standalone computer machine-device, and additional use or applications facilitated by means comprising of a network. A network TOUCHCOM therefore, presents to a user, client, user-client, host, machine-device, or touch-device, performance of touch by means comprising of a network, comprising for personal, informational, social, and professional purposes.

A use of network TOUCHCOM is in user, client, user-client, host, machine-device, or touch-device, asynchronous and/or real-time performance of touch by means comprising of a wireline or wireless network, comprising touch information reception from, or transmission to, another user, client, user-client, host, machine-device, or touch-device. A pre-programmed, stored, or INPUT, touch information is utilized by a transmitting user, client, user-client, host, machine-device, or touch-device, and received by a receiving user, client, user-client, host, machine-device, or touch-device. A said network touch communication, comprising the additional element of touch, is employed in network TOUCHCOM for performance, with means comprising of an operating system, program, application, service, or platform.

The use or applications of said network TOUCHCOM, comprises, user-user communication of touch, by means of a network computer or touch-device. Another application is employing a network computer for scalable PERFORMANCE of touch with means of touch-devices, comprising a jacket, wearable, massager, hugging doll, or the like. An application example of a said network TOUCHCOM, is for performance of touch to a distributor, retailer, or consumer in advertising, marketing, or sale of a product comprising of a sensation of touch. A further application is in sampling a product comprising of a sensation of touch, comprising a textile, garment, wearable, or the like. The said applications by means comprising of a network, presents a one-stop-shop location with a simple, convenient, economical, and centralized forum for sampling, testing, selecting, or procuring, of a product comprising a sensation of touch.

The said examples explain the barebones utility, use, and applications of TOUCHCOM, overlapping in the purpose of use or application by means of, a network computer machine-device with means comprising of a connection to a touch-device, or a touch-device with means comprising for a connection to a said machine-device.

Phone: A phone machine-device, as defined herein, is a phone comprising a connection to a phone, hybrid, or other network. A said phone employs a TOUCHCOM system or process, for performance of touch, with means comprising of a connection to a touch-device. A said TOUCHCOM on a phone machine-device has use, and applications, comprising for personal, informational, social, and professional purposes.

A phone machine-device performance of touch comprises, on a usage of said phone, or programming said phone with means of a clock therein. A said phone with means of a clock comprises being used similar to an alarm clock, for a time-based PERFORMANCE of touch with means of a touch-device.

A TOUCHCOM system or process by means of a phone machine-device, comprises a feature for performance of touch comprising on, any incoming call; or an incoming call from a particular phone or phone-group, as identified with means of a caller-id feature on, or connected to, said phone. Another feature of said TOUCHCOM is where a phone machine-device comprises performance of touch on a specific usage of said phone, comprising, when a user, initiates a call to; listens to a voice message from; or receives a call from; another user, client, user-client, or machine-device.

The said examples explain the utility, use, and applications of TOUCHCOM, overlapping in the purpose of use or applications by means of, a phone machine-device with means comprising of a connection to a touch-device, or a touch-device with means comprising for a connection to a said machine-device.

(4) MOBILE TOUCHDEV: A “MOBILE TOUCHDEV” is a mobile personal touch-device. The said touch-device comprises user-controls for operation thereof. The said controls are operated by means comprising instant user control, manual or electronic programming, or a hybrid of the aforesaid. The embodiment of said touch-device comprises manual, mechanical, electro-mechanical, or electrical, user-controls. A TOUCHCOM system or process for PERFORMANCE of touch by means of a MOBILE TOUCHDEV, is independent of any other machine, apparatus, or device; with the exception of, a MOBILE TOUCHDEV program download from, or upload into, a machine-device or touch-device, or PERFORMANCE of touch with means of a connection from a machine-device or touch-device.

The operation of said MOBILE TOUCHDEV is controlled by a user or client, with means comprising user-controls embodying said device. The said MOBILE TOUCHDEV comprises user-controls for operation, and means comprising for a connection to a machine-device for operation or co-operation. The activation, deactivation, event-based operation, and PERFORMANCE, of said device is facilitated with means comprising of said user-controls thereon. The said user-controls comprise functional, and/or PERFORMANCE, means for operation of said device.

A MOBILE TOUCHDEV use comprises while a user is on travel and/or mobile. The said device is capable of PERFORMING of touch, comprising while in user possession. An operational example of a MOBILE TOUCHDEV, comprises, activation of said device while gaming, or walking, and deactivation thereof at a time of choice to the user or client. A MOBILE TOUCHDEV is an efficient, convenient, and a mobile-friendly device.

The new or enhanced TOUCHCOM system or process, by means of, a standalone or network computer, a phone, and/or a touch-device, is facilitated for performance of touch by means of a said machine-device and/or touch-device. The utility, use, and applications of TOUCHCOM comprise personal, informational, social, and professional, by means of a said machine-device and/or touch-device. The aforesaid utility, use, and applications, are a barebones explanation and are however, not a limitation of TOUCHCOM by means of a machine-device and/or touch-device.

### BRIEF DESCRIPTION OF THE DRAWINGS

The objectives of this invention will become more apparent, and the invention best understood from the following description of TOUCHCOM, when read in reference to the accompanying drawings, wherein:

FIG. 1 illustrates a standalone computer with means of a connection to a TOUCHDEV.

FIG. 2 illustrates a system diagram of FIG. 1, for PERFORMANCE of touch.

FIG. 3 illustrates a one-way TOUCHCOM, by means of a computer communication network.

FIG. 4 illustrates a two-way TOUCHCOM, by means of a communication network.

FIG. 5 illustrates a network computer with means of a connection to multiple TOUCHDEVs.

FIG. 6 illustrates a TOUCHDEV with an external TOUCHCNTRLR.

FIG. 7 illustrates a TOUCHDEV with an integrated TOUCHCNTRLR.

FIG. 8 illustrates a wireless TOUCHDEV.

FIG. 9 illustrates a TOUCHDEV for performing touch, comprising heat.

FIG. 10 illustrates a MOBILE TOUCHDEV with mechanical user-controls.

FIG. 11 illustrates a MOBILE TOUCHDEV with electro-mechanical user-controls.

FIG. 12 illustrates a wireless MOBILE TOUCHDEV with electronic user-controls.

FIG. 13 illustrates a MOBILE TOUCHDEV with a feature for setting or selecting of a sensation of touch, comprising heat, for PERFORMANCE.

### DESCRIPTION OF THE SYSTEM OR PROCESS

This invention pertains to the communication, and production, of touch. The word “communication” as defined herein, comprises, forward or reverse user-machine, user-client, or user-user, communication within scope of this invention. The said word communication further comprises, forward or reverse machine-client, or machine-machine, communication.

A user-machine communication comprises, when a user interacts with a machine-device, or touch-device. A user-client communication comprises, when a user interacts with a client program, application, service, or platform, in, or by means of, a machine-device or touch-device. A user-user communication comprises, when a user, client, user-client, or host, interacts with another user, client, user-client, or host, by means of, a machine-device with means comprising of a connection to a touch-device, or a touch-device with means comprising for a connection to a machine-device, by means comprising of a network. A user-user communication therein comprises between, a computer user and another computer user, a phone user and another phone user, a computer user and a phone user, or vise-versa, and further between a touch-device user and another touch-device user by means comprising of a network.

A machine-client communication comprises, when a machine-device or touch-device communicates, with a client operating system, program, application, service, or platform, or vice versa. A machine-machine communication comprises when a machine-device communicates, with another machine-device or a touch-device, or internally therewithin; further comprising when a touch-device communicates, with a machine-device or another touch-device, or internally therewithin.

The word “production” as defined herein, is PERFORMING a production, output, contact, or a combination, comprising for a sensation of touch, by means of, with means of, on, or from, a touch-device comprising a touch-source, within scope of this invention. The said word production on or from a touch-device, comprises an output, or combination, of one or more touch sensation in, on, or from, a single touch-source, or multiples thereof.

A TOUCHCOM system or process, comprises, performance of touch by means of, a computer or phone machine-device with means comprising of a connection to a touch-device, or a touch-device with means comprising for a connection to a machine-device or touch-device. A said machine-device employs a TOUCHCOM system or process to communicate touch information to another user, client, user-client, host, machine-device, or touch-device.

Touch information in a machine-device comprises for performing communication to a touch-device, with means comprising of a touch-device driver that is pre-, device plug-in-, or remotely, installed into said machine-device. The said TOUCHCOM, when a TOUCHCNTRLR is present, in the connection between said machine-device and touch-device, or integrated on said touch-device, communicates touch information to said TOUCHCNTRLR instead, with means comprising of a device driver. The said communicated touch information, is processed by means of the said TOUCHCNTRLR with control settings thereon, and thereof communicated to the touch-device for PERFORMANCE of touch.

In an enhanced TOUCHCOM, a TOUCHCNTRLR comprises regulating production of touch, heat, motion, or a combination thereof, on, of, or from, a touch-device. The word ‘touch’, is replaceable, or combinable, with ‘heat’ and/or ‘motion’ on a said enhanced TOUCHCOM, when said ‘heat’, and/or ‘motion’, is associated with a sensation of touch.

The analogy of a TOUCHCOM system or process, is the communication and/or play of voice or audio, by means of a computer or phone machine-device with means comprising of a connection to a speaker and/or microphone. A further analogy, comprising, performing communication is sending of a fax by means of a computer, phone, hybrid, or other network; and performing production is printing of a document with means of a computer printer.

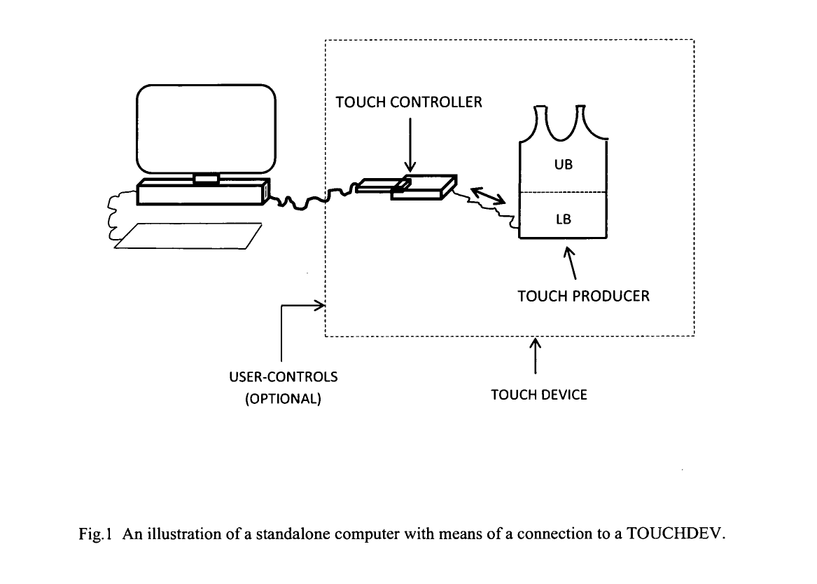

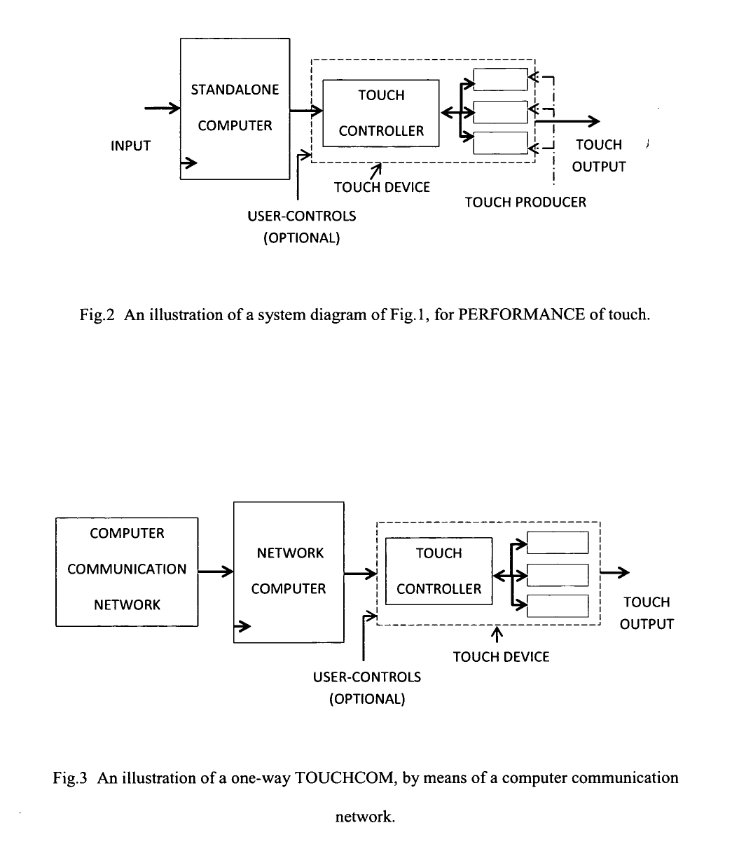

FIG. 1 illustrates a standalone computer machine-device with means of a connection to a TOUCHDEV. The said figure shows presence of an optional TOUCHCNTRLR, in the connection between said standalone computer and TOUCHDEV. The said TOUCHDEV comprises PERFORMANCE of touch, upon communication of touch information from said standalone computer to said TOUCHCNTRLR, with means comprising of a device driver. A TOUCHDEV comprises manual user-controls, comprising for co-operation. For purposes of this specification, and drawings, a “TOUCHDEV” is replaceable with a “touch-device”.

FIG. 2 illustrates a TOUCHCOM system or process diagram of FIG. 1. The said diagram shows TOUCHCOM for PERFORMANCE of touch, by means of a standalone computer machine-device with means of a connection to a TOUCHDEV, with presence of an optional TOUCHCNTRLR in said connection. A said TOUCHCNTRLR, alternatively comprises controls for touch, heat, and/or motion, for performance with means comprising of a connection to a touch-device comprising for performance of touch, heat, and/or motion.

Having illustrated TOUCHCOM by means of a standalone computer machine-device, the illustrations present the said for a network computer machine-device. FIG. 3 illustrates a TOUCHCOM system or process for a one-way communication of touch information, by means of a computer communication network. Here, a network computer machine-device transmits or receives touch information from a user, client, user-client, host, machine-device, or touch-device, with means comprising of a network communication channel by means comprising of a computer network. A said TOUCHCOM by means of a network computer machine-device, is similar to a TOUCHCOM by means of a standalone computer machine-device, with the additional capability to perform a one-way TOUCHCOM by means comprising of a computer network. The said computer communication network may, instead, be a phone, hybrid, or other, communication network for facilitating a said one-way TOUCHCOM.

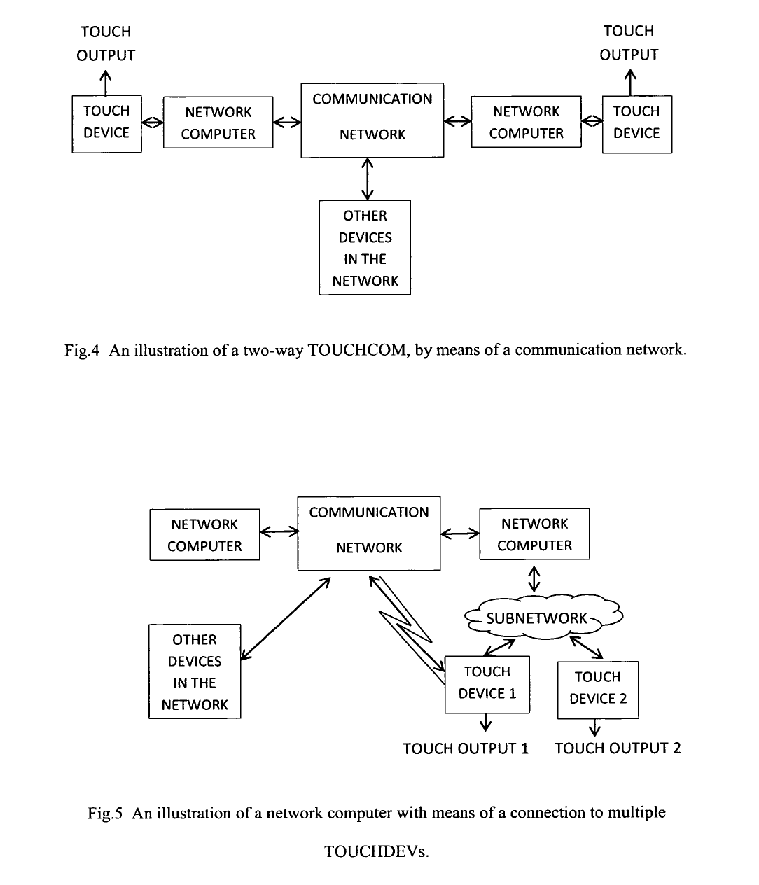

FIG. 4 illustrates a TOUCHCOM system or process for a two-way communication of touch information, by means comprising of a communication network. Here a communication system or process is capable of two-way communication of touch information, by means comprising of a network. A said two-way communication of touch is employed by means comprising of, receiving touch information from, and/or transmitting touch information to, a user, client, user-client, host, machine-device, or touch-device, by means comprising of a communication network. A said communication network comprises a computer, phone, hybrid, or other network.

A network communication system, comprises, machine-devices, electronic communication devices, and/or a touch-devices, in said network. A said network further comprises means of a connection to a sub-network. A said sub-network comprises a Personal Area Network (“PAN”), or other sub-network, in said network. The said figure shows network electronic devices comprising of, computer or phone machine-devices, wireless communication devices, and touch-devices, in the network.

FIG. 5 illustrates a TOUCHCOM system or process for PERFORMANCE of touch, with means of a connection, or connections, to multiple TOUCHDEVs. The said may be facilitated for independent, or coordinated, PERFORMANCE of touch by means comprising of a network or sub-network. A network machine-device communicates, with another machine-device, or to a touch-device, comprising said network or sub-network, with means comprising of a network communication channel by means comprising of a network. The said network comprises a Local Area Network (“LAN”), a Personal Area Network (“PAN”), or other network, for performance of touch with means comprising of a network touch-device. The said figure shows a network computer with means of a connection, or connections, to a sub-network comprising TOUCHDEV1, and TOUCHDEV2. The said figure also shows TOUCHDEV1 comprising a direct wireless connection to said network.

A network computer communicates touch information to a network touch-device, with means comprising of a network device driver. The said network computer comprises capability of communicating touch information for independent, or coordinated, PERFORMANCE of touch with means comprising of a connection, or connections, to network touch-devices in said multi touch-device network.

A network computer machine-device with means comprising of a connection, or connections, to multiple touch-devices, is similar to a network computer machine-device with means comprising of a connection, or connections, to multiple speakers, where a said speaker is, or speakers are, performance playable either independently, or in coordination. A further similarity exists, in the case of a network computer machine-device with means comprising of a connection, or connections, to multiple network printers, with means to pre-assign, or assign, a print job.

The performing communication of touch by means of a network is further employed, by means comprising of a remote network computer machine-device. A said remote network computer comprises PERFORMANCE of touch, directly, with means of a connection to a network touch-device, by means of a network.

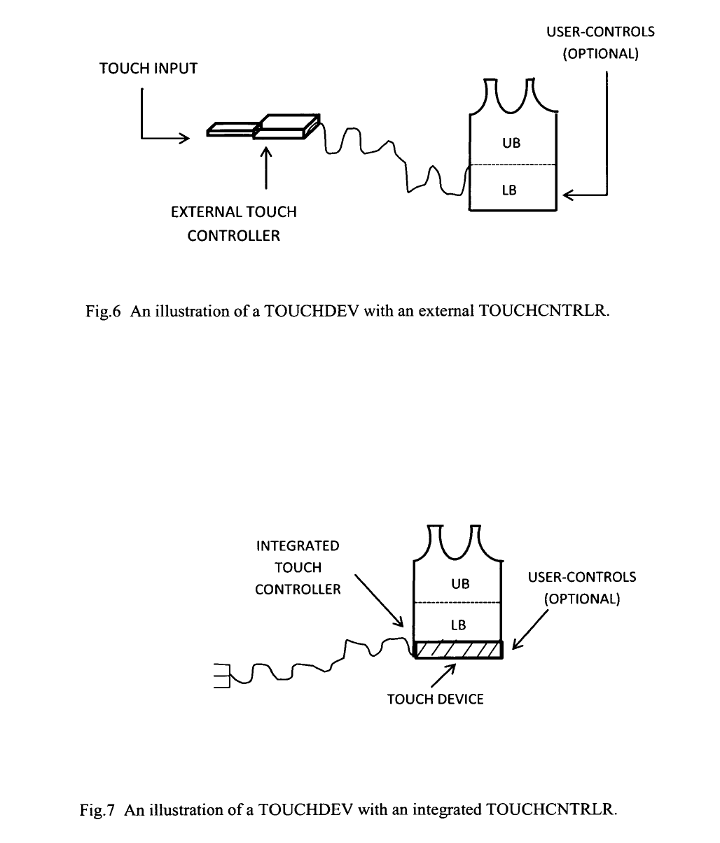

FIG. 6 illustrates a more detailed view of an external touch controller with means of a connection to a TOUCHDEV. Here, a machine-device connects to a TOUCHDEV, with presence of said external TOUCHCNTRLR in the connection between said machine-device and TOUCHDEV. A said machine-device communicates touch information to said external TOUCHCNTRLR, with means comprising of a device driver. The said communicated touch information is processed with means comprising of control settings on said TOUCHCNTRLR, and communicated to said TOUCHDEV for PERFORMANCE of touch. The “UB”, and “LB”, notation on the touch-device, respectively denotes the upper, and lower, body abdomen area of the embodiment for performance of touch on, or from, said touch-device.

FIG. 7 illustrates a TOUCHDEV with an integrated TOUCHCNTRLR. The said integration follows technology trends in integrating parts, components, and subsystems, to make a system or process more efficient. The figure shows said TOUCHDEV with a port connector, for connecting said TOUCHDEV to a machine-device, another touch-device, or a power source.

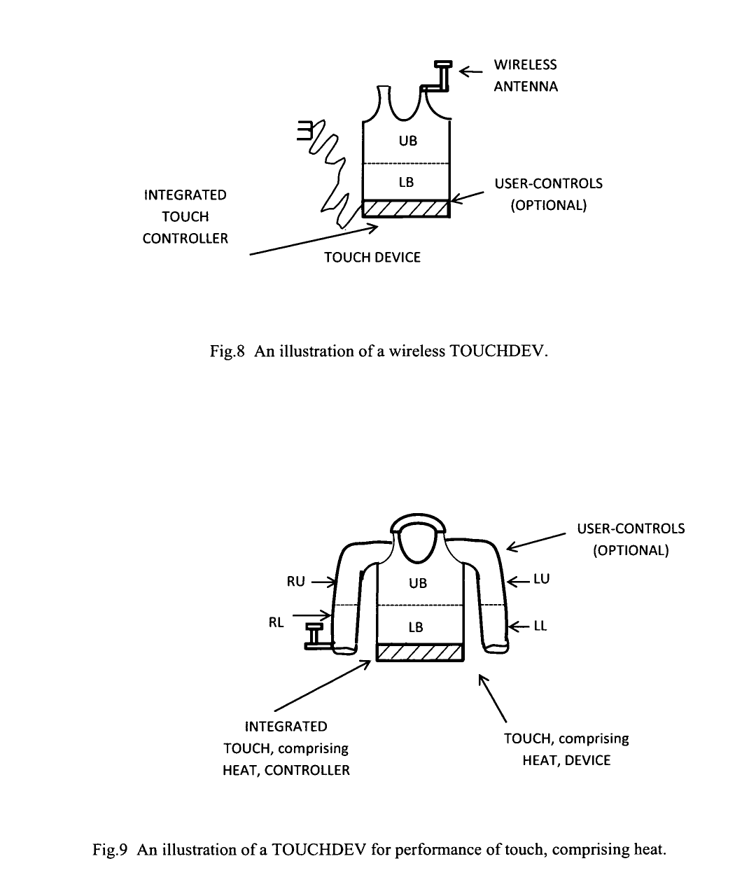

FIG. 8 illustrates a wireless TOUCHDEV. A wireless TOUCHDEV consists of a wireless antenna-, -receiver for receiving, or -transceiver for communicating, comprising of touch information. A wireless TOUCHDEV with a transceiver comprises command, control, communication, and/or coordination, by means of a machine-device and/or a touch-device. A machine-device or touch-device communicates touch information to a wireless TOUCHDEV, with means comprising of a wireless device driver, for PERFORMANCE of touch.

An enhanced TOUCHCOM comprises a machine-device or touch-device communication of touch information, for PERFORMANCE on a wireless TOUCHDEV, by means comprising of a network. Another enhanced TOUCHCOM, comprises, a network touch-device communication between, and/or coordinated PERFORMANCE of touch on or from, a said other.

FIG. 9 illustrates a TOUCHDEV for PERFORMANCE of a sensation of touch, comprising heat. A machine-device communicates touch, comprising heat, information to said TOUCHDEV, comprising for PERFORMANCE of a sensation of touch, comprising heat, on or from said device. The said figure shows a TOUCHDEV with an embodiment of a jacket. The “LU”, and “LL”, controls correspond to performance of touch, comprising heat, respectively on the left-upper, and left-lower, hand area of the said embodiment. Similarly “RU”, “RL”, “UB”, and “LB”, controls correspond to performance of touch, comprising heat, respectively on the right-upper hand, right-lower hand, upper-body abdomen, and lower-body abdomen, area of the said embodiment.

The said illustrations presented, and explained, performance of touch with means of a TOUCHCOM system or process, by means of, a machine-device with means comprising of a connection to a touch-device, and a touch-device with means comprising for a connection to a machine-device or touch-device.

A TOUCHCOM system or process is employed, with means comprising of an operating system, program, application, service, or platform. A TOUCHCOM for performance of touch, by means of a machine-device with means comprising of a connection to a touch-device, is similar to communication and/or play of voice or audio, by means of a machine-device with means comprising of a connection to a speaker and/or a microphone. A TOUCHCOM for performing communication of touch information is similar to: communication of voice or audio by means of a computer or phone machine-device; or communication of text with means of an e-mail program, application, service, or platform; both the said by means comprising of a network, comprising of the internet. The said communication comprises communicating a pre-defined, programmed, or INPUT, touch information, between a user, client, user-client, host, machine-device, or touch-device, and another user, client, user-client, host, machine-device, or touch-device, by means comprising of a network.

A touch-device receives the necessary operational power, with means of a connection to a power supply. The said power supply is facilitated, with means comprising of a machine-device power source connection to a touch-device. A said power supply may alternatively be facilitated with means of a power source comprising a battery, plugging said device into an electrical power outlet comprising for recharging, or sharing a power source.

### MOBILE TOUCHDEV

A MOBILE TOUCHDEV is a mobile personal touch-device. The said device is functionally efficient for PERFORMANCE of touch, while in possession of a user. The features of a MOBILE TOUCHDEV, comprise, a lightweight embodiment for user possession, and user-controls for operation, thereof. A MOBILE TOUCHDEV comprises an embodiment similar to a jacket, human wearable, massager, hugging doll, or the like, comprising for a smooth, rough, pressure-point, and/or rugged operation.

A TOUCHCOM system or process for PERFORMANCE of touch, by means of a MOBILE TOUCHDEV, is somewhat similar to that of a machine-device with means of a connection to a touch-device. However, a MOBILE TOUCHDEV is an independent device in embodiment, comprising operation. The said device comprises user-controls that are manual and/or programmable. The PERFORMANCE of touch on, or from, a MOBILE TOUCHDEV is controlled by, the user whom, or the client which, with means of said controls selects or sets control subjecting operation of the said device. The said device comprises manual, mechanical, electro-mechanical, and/or electrical user-controls, comprising an optional feature for programmability.

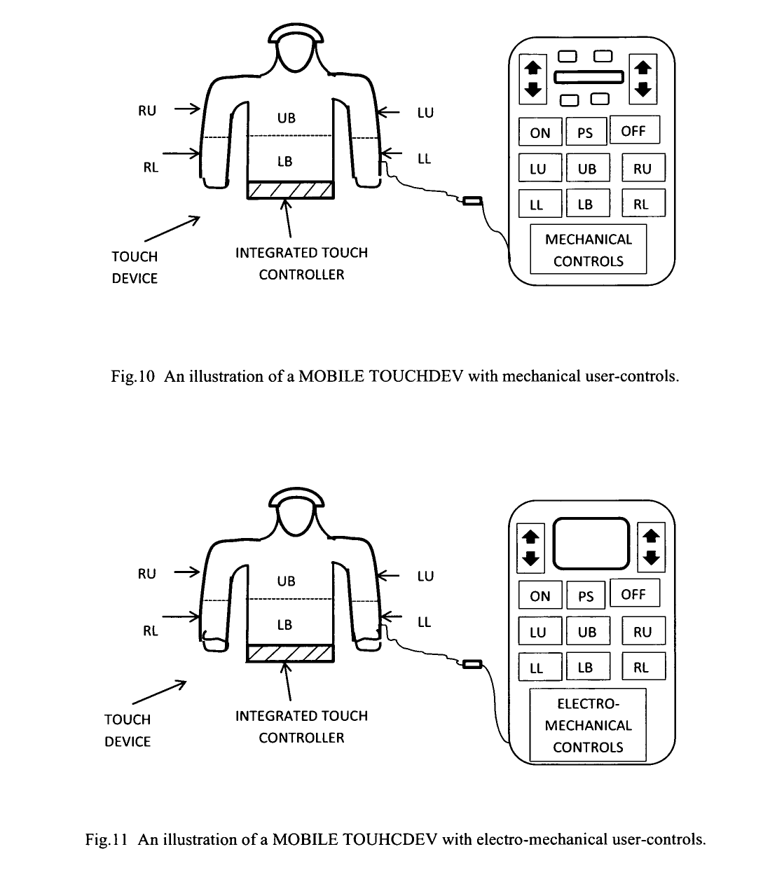

FIG. 10 illustrates a MOBILE TOUCHDEV consisting mechanical user-controls. The said device is operated by means comprising said mechanical and/or manual controls on said device, for activation, deactivation, or PERFORMANCE, of touch thereon or therefrom. A user operation on user-controls on the device-controller console effects PERFORMANCE of touch on said device. The said figure shows mechanical controls, named ON, OFF, and PS, for switching the said device on, off, and for pausing. The said figure shows an embodiment for adjusting the rate of production, or strength, of touch on or from said device. The arrow controls on the top left, and right, of said device controller console, show mechanical controls for adjusting the rate of production, and strength, of touch on or form said device. One of said controls comprises being alternatively used for functional, or operational, timing of said device. The said figure shows mechanical controls, named LU, LL, RU, RL, UB, and LB, corresponding to performance of touch, respectively, on said embodiment's left-upper hand, left-lower hand, right-upper hand, right-lower hand, upper-body abdomen, and lower-body abdomen, areas on, of, or from the said device. A user or client effects operation of said MOBILE TOUCHDEV, by means of activating a user-control, namely LU, LL, RU, RL, UB, or LB, or a combination thereof, for performance of touch at pre-defined areas of the said touch-device. The said device controller communicates user-control input to said MOBILE TOUCHDEV comprising for PERFORMING production of touch on, of, or from, the said device.

FIG. 11 illustrates a MOBILE TOUCHDEV consisting electro-mechanical user-controls. The said device is operated by means comprising said electrical, mechanical, or electro-mechanical, and/or manual, controls on the said device, for activation, deactivation, or PERFORMANCE, of touch thereon or therefrom. The said figure shows a device controller console similar to that of FIG. 10, the contrast being electro-mechanical, instead of mechanical only, user-controls on the said device controller of FIG. 11.

The said figure shows an optional display screen, adjacently between said electro-mechanical controls, for monitoring PERFORMANCE of said device, comprising during operation. The said display on said device, comprises operational information on, the amount of touch or time remaining on; the rate of production or the strength of touch on or from; and/or the amount of power on; the said device. The said display monitoring of performance, may be facilitated on any touch-device, similar to that for a MOBILE TOUCHDEV as explained herein preceding.

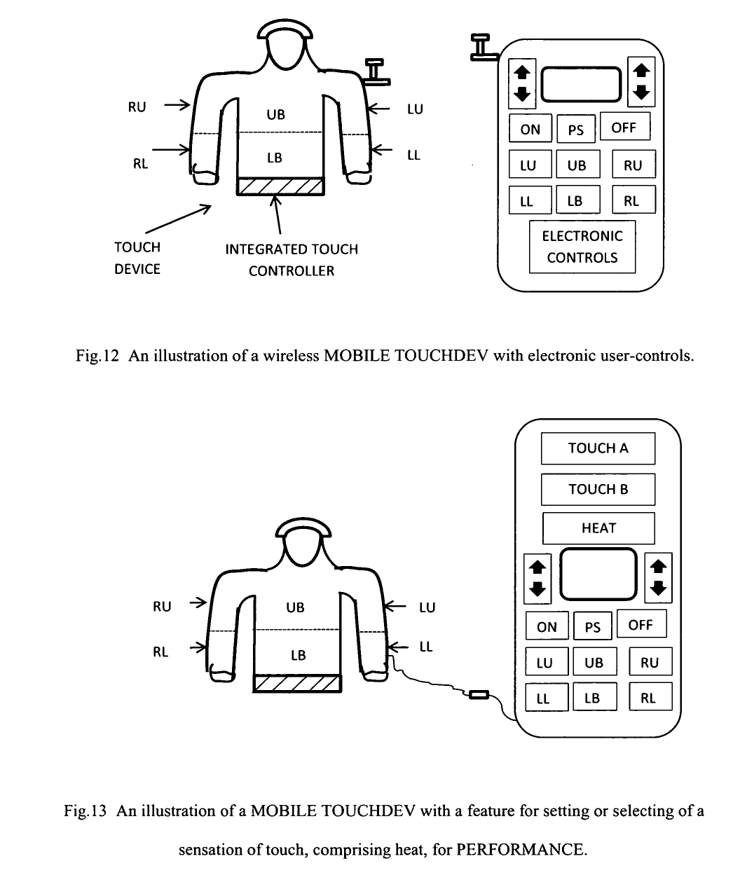

FIG. 12 illustrates a wireless MOBILE TOUCHDEV consisting electrical, comprising electronic, user-controls. The said device is operated by means comprising said electrical comprising electronic, and/or manual, controls on said device, for activation, deactivation, or PERFORMANCE, of touch thereon or therefrom. The said figure shows a device controller console similar to that of FIG. 11, the contrast being electrical comprising electronic, instead of electro-mechanical, user-controls on the said device controller of FIG. 12.

FIG. 13 illustrates an enhanced MOBILE TOUCHDEV, comprising user-controls for setting or selecting a sensation, from multiple sensations, of touch, comprising heat, for PERFORMANCE thereon or therefrom. The said user-controls, for setting or selecting a sensation of touch are shown named TOUCH A, and TOUCH B, and for setting or selecting heat is shown named HEAT, on said device controller console.

A MOBILE TOUCHDEV receives the necessary operational power, with means of a connection to a power supply. The said power supply is facilitated with means of a power source comprising a battery, plugging said device into an electrical power outlet comprising for recharging, or sharing a power source.

The illustrations presented herein are however, not a limitation of a TOUCHCOM, nor a touch-device, wherein the specification comprises all designs, and embodiments, within scope of this invention.

Touch Data Communication: The system or process for communication of touch, with means comprising of a network communication channel by means comprising of a network, in the absence of a network communication protocol, or standard, for the said communication of touch information, is facilitated by means comprising of “touch data communication”. The said touch data communication comprises receiving and/or transmitting, comprising “touch communication data”, by means comprising of a network. A TOUCHCOM system or process, for communication of touch by means comprising of a network, is presented herein-following:
Transmit: A network user, client, user-client, host, machine-device, or touch-device, transmits touch information to another user, client, user-client, host, machine-device, or touch-device, with means comprising of a network communication channel by means comprising of a network.

A network TOUCHCOM utilizes pre-defined, programmed, or INPUT, touch information in said transmitting communication. The said touch information is processed before, or during, transmitting communication, with means comprising of data mapping the said touch information into “touch communication data”. The said forward transformed “touch communication data” is thereupon transmitted, by means comprising of a network.

Receive: A network user, client, user-client, host, machine-device, or touch-device, receives touch information from a user, client, user-client, host, machine-device, or touch-device, with means comprising of a network communication channel by means comprising of a network.

The said received touch information is processed during, or after, receiving “touch communication data”, with means comprising of reverse data mapping the said “touch communication data” into the reverse transformed, communicated touch information. The said transmitted and network machine-device, or touch-device, received touch information is thereupon utilized by TOUCHCOM, for performance of touch.

Communication and Processing: Network communication of touch information, comprises, (1) transmitting “touch communication data” to, or (2) receiving “touch communication data” from, a user, client, user-client, host, machine-device, or touch-device, by means comprising of a network. The said touch information comprises being utilized for performance of touch on a machine-device, or touch-device. The said performance comprises processing comprising customization, storing, and/or communicating, of touch information, for performance with means comprising of a network or non-network operating system, program, application, service, or platform, on a machine-device or touch-device. The said touch information may be assigned a null, comprising, during TOUCHCOM processing, storing, and/or communicating, of touch information for performance on a machine-device, or touch-device.

Herein-following is a summary of a TOUCHCOM system or process, by means of, a standalone or network computer, a phone, and a MOBILE TOUCHDEV.

(1) Standalone Computer: A standalone computer machine-device receives touch information, with means comprising of an INPUT. The said received touch information is employed, with means comprising of an operating system, program, application, service, or platform, on said standalone computer for performance of touch.

A standalone computer machine-device comprises a wireline or wireless connection to a touch-device. The said standalone computer communicates touch information with means of a connection to a touch-device, for PERFORMANCE of touch therefrom.

A TOUCHCOM system or process on, a standalone computer machine-device with means comprising of a connection to a touch-device, or a touch-device with means comprising for a connection to a standalone computer, presents for processing, storing, and/or communicating, of touch information for performance of touch.

(2) Networked Computer: A network computer machine-device receives touch information, with means comprising of an INPUT, by means comprising of a network. A said network computer comprises employing the means of a network, comprising of the interne, for performance of touch.

A network computer comprises, receiving touch information from, and/or transmitting touch information to, a user, client, user-client, host, machine-device, or touch-device, by means comprising of a network. A network computer communicated touch information, is thereupon processed, stored, and/or communicated, for performance with means comprising of a user, client, user-client, host, machine-device, or touch-device's operating system, program, application, service, or platform.

A said network computer communicates touch information with means of a wireline or wireless connection to a touch-device, for PERFORMANCE of touch. The performance of touch, by means of a network computer machine-device with means comprising of a connection to a touch-device, is similar to the performance of touch, by means of a standalone computer machine-device with means comprising of a connection to a touch-device, with the additional capability of said network computer for performance of touch to, or from, a user, client, user-client, host, machine-device, or touch-device, by means comprising of a network.

An enhancement of a TOUCHCOM system or process, by means of a network computer machine-device, is enablement of asynchronous and/or real-time performance of touch, by means comprising of a computer, hybrid, or other network. The said enhancement of TOUCHCOM by means of a said network computer, comprises, receiving and/or transmitting touch information during communication between a user, client, user-client, host, machine-device, or touch-device, and another user, client, user-client, host, machine-device, or touch-device, comprising in one-, two-, and/or multi-way communication by means comprising of a network.

A TOUCHCOM system or process by means of, a network computer machine-device with means comprising of a connection to a touch-device, or a touch-device with means comprising for a connection to a network computer, presents for processing, storing, and/or communicating, of touch information for performance of touch.

(3) Phone: A phone machine-device comprises a wireline or wireless connection to a touch-device for PERFORMANCE of touch. The said connection is similar to, a phone machine-device connection to an external caller-id device or DSL router, or a computer machine-device connection to a touch-device.

A phone machine-device communicates touch information to a touch-device, either, directly; or indirectly with means of a TOUCHCNTRLR, in the connection between said phone and touch-device, or integrated on said touch-device; for PERFORMANCE of touch.

An enhancement of TOUCHCOM by means of a phone machine-device, is enablement of asynchronous and/or real-time performance of touch, by means comprising of a phone, hybrid, or other network. The said enhancement of TOUCHCOM by means of said phone, comprises, receiving and/or transmitting touch information, during communication between a user, client, user-client, or host, and another user, client, or user-client, or host, comprising in one-, two-, and/or multi-way communication by means comprising of a network.

A TOUCHCOM system or process by means of, a phone machine-device with means comprising of a connection to a touch-device, or a touch-device with means comprising for a connection to a phone, presents for processing, storing, and/or communicating, of touch information for performance of touch.

(4) MOBILE TOUCHDEV: A MOBILE TOUCHDEV is a unique touch-device, in that, the PERFORMANCE of touch thereon, or therefrom, is independent of any other device, apparatus, or machine.

A user activates a MOBILE TOUCHDEV comprising manually, for PERFORMANCE of touch. A user operates a MOBILE TOUCHDEV, with means comprising of user-controls embodying said device. A said touch-device PERFORMANCE of touch, comprises on a user setting or selection of user-controls on said device. A said MOBILE TOUCHDEV comprises of an optional TOUCHCNTRLR, for regulating PERFORMANCE of touch on or from said device.

A said MOBILE TOUCHDEV comprises an enhanced feature, for user or client programmability for PERFORMANCE of touch. A said MOBILE TOUCHDEV may be enhanced to perform similar to a TOUCHDEV, for a machine-device performance of touch with means of a connection thereto.

A TOUCHCOM system or process by means of, a MOBILE TOUCHDEV, or a MOBILE TOUCHDEV with means comprising for a connection to a machine-device, presents for processing, storing, and/or communicating, of touch information for performance. The said TOUCHCOM by means of a MOBILE TOUCHDEV has numerous personal, social, professional, consumer, and business use, and applications.

### Enhancements on a Touch-Device:

The additional or enhanced features for a touch-device, comprises: (1) user- or client-controls for manual and/or programmable setting or selecting of, a rate of production, or a strength, of touch on or from a touch-device; (2) capability for PERFORMING communication to a machine-device or another touch-device, of a manual and/or programmable user- or client-control setting, selection, or input, on or into a touch-device; (3) user-controls for setting, selecting, or input of a sensation, from multiple sensations, of touch comprising heat and/or motion for PERFORMANCE by means of, with means of, on, or from, a touch-device; (4) capability for PERFORMANCE of multiple sensations of touch by means of, with means of, on, or from, a touch-device; facilitated by means of connecting thereto or thereinto, multiple touch-sources, or one touch-source comprising multiple sensations, each with a unique sensation of touch; (5) reuse of a touch-device by means comprising refilling, re-supplying, or changing, the touch-source comprising touch contact; a procedure which is similar to: refilling of a bottle of water, air in a tire, lighter fluid, or gas cylinder; re-supplying a contact surface with a surface material; or changing of an accessory, part, or component, similar to a coffee filter; (6) functional or operational timing for activation, deactivation, and/or interval of use, of a touch-device; and/or (7) supplying power to a touch-device with a renewable energy source.

An enhancement of a TOUCHCOM system or process of this invention comprises, embedding a touch-device onto or into a machine-device, and sensing of touch with means of a touch sensor. A said touch sensor comprises sensing of touch, from an element in contact with, or connected to, said sensor. A said embedded touch-device, or a touch sensor, comprises being utilized with TOUCHCOM for performance of touch.

An enhancement on a touch-device, comprises, enablement of user or client programmability thereon. Another enhancement on a touch-device, comprises, enablement of time-based, operation thereof, or functionalities thereon or therefor.

### Enhancements on TOUCHCOM:

A network TOUCHCOM system or process enhances network communication, by means of a network machine-device or touch-device, by presenting to a user, client, user-client, host, machine-device, or touch-device, the additional element of touch in said network communication. A said network TOUCHCOM requires enhancements, comprising, in a network operating system, program, application, service, and/or platform, for facilitating said network touch communication.

A further enhancement of TOUCHCOM is in communicating touch information, by means of a touch-device, to a machine-device or another touch-device, by means comprising of a network. The said TOUCHCOM is an enhanced system or process for INPUT of touch information to a machine-device, or another touch-device, for performance of touch.

A further enhancement of TOUCHCOM is a machine-device connectable portable, comprising mobile, TOUCHDEV, referred to herein as “PM-TOUCHDEV”. A PM-TOUCHDEV is a portable, comprising mobile, embodiment of a TOUCHDEV.

A machine-device communicates touch information to a PM-TOUCHDEV, with means of a connection thereto, with means comprising of a device driver. The performance of touch by means of a PM-TOUCHDEV with means comprising of, or for, a connection to a machine-device or touch-device, is similar to the performance of touch by means of a TOUCHDEV with means comprising of, or for, a connection to a machine-device or touch-device. The said PM-TOUCHDEV is suitable for wireline or wireless use with a portable, comprising mobile, machine-device.

Another enhancement of TOUCHCOM is a pre-programmed or programmable touch-device, referred to herein as “E-TOUCHDEV”. The said E-TOUCHDEV is a permanent, desktop, stationary, or portable, embodiment of a MOBILE TOUCHDEV.

An E-TOUCHDEV comprises user or client programmability of touch information for PERFORMANCE. The PERFORMANCE of touch by means of an E-TOUCHDEV with means comprising of, or for, a connection to a machine-device or touch-device, is similar to the PERFORMANCE of touch by means of a MOBILE TOUCHDEV with means comprising of, or for, a connection to a machine-device or touch-device. An enhancement of an E-TOUCHDEV comprises network adaptability for independent, or coordinated, PERFORMANCE of touch, by means comprising of a network. The E-TOUCHDEV comprises indoor or outdoor applications.

The said PM_TOUCHDEV, and E-TOUCHDEV, are classified within the definition of, a TOUCHDEV, or a MOBILE TOUCHDEV, within scope of this invention.

I claim:

1. A system or process for performance of touch comprising heat and/or motion, by means of, a computer or phone machine-device, or a touch-device.

2. A device, apparatus, or machine, of claim 1, with means for a connection to a computer or phone machine-device, or a touch-device.

3. A device, apparatus, or machine, of the system or process of claim 1, for performance of touch comprising heat and/or motion, named or classified a TOUCHDEV.

4. An element, component, or part, of a TOUCHDEV of claim 3, for use therein, thereon, or therewith.

5. A TOUCHDEV of claim 3, employing the means of a power source, comprising a battery.

6. An operating system, program, application, service, or platform, of claim 1, that enables processing, storing, and/or communicating, of touch comprising heat and/or motion information, for performance of touch comprising heat and/or motion.

7. An operating system, program, application, service, or platform, of claim 1, for asynchronous and/or real-time performance of touch, heat, and/or motion, comprising with a performance output combination comprising of, text, hyperlink, audio, image, and/or moving picture.

8. A system or process for performance of touch comprising heat and/or motion, by means of a user, or client, controlled personal touch-device.

9. A device, apparatus, or machine, of claim 8, with means for a connection to a computer or phone machine-device, or a touch-device.

10. A device, apparatus, or machine, of claim 8, for performance of touch comprising heat and/or motion, named or classified a MOBILE TOUCHDEV.

11. An element, component, or part, of a MOBILE TOUCHDEV of claim 10, for use therein, thereon, or therewith.

12. A MOBILE TOUCHDEV of claim 10, employing the means of a power source, comprising a battery.
